(19) United States
(12) Patent Application Publication
(10) Pub. No.: US 2024/0116221 A1
(43) Pub. Date: Apr. 11, 2024

(54) METHOD FOR CURING ROOM TEMPERATURE CURABLE SILICONE COMPOSITIONS

(71) Applicant: DOW SILICONES CORPORATION, Midland, MI (US)

(72) Inventors: Thomas DAVIDIAN, Seneffe (BE); Davide Dei Santi, Seneffe (BE); Gregory CHAMBARD, Seneffe (BE); Frederic GUBBELS, Seneffe (BE)

(21) Appl. No.: 18/277,297

(22) PCT Filed: Feb. 16, 2022
(86) PCT No.: PCT/US2022/016663

§ 371 Date: Aug. 15, 2023

Related U.S. Application Data
(60) Provisional application No. 63/150,333, filed on Feb. 17, 2021.

(51) Int. Cl. B29C 37/00; B29C 33/00; B29C 39/00; B29C 39/02; B29C 39/26; C08J 5/00; E06B 3/663; E06B 3/673

(52) U.S. Cl. CPC B29C 37/006; B29C 33/0038; B29C 39/003; B29C 39/02; B29C 39/26; C08J 5/00; E06B 3/66333; E06B 3/67304; B29K 2083/00; C08J 2383/05

(57) ABSTRACT

This disclosure relates to a method for reducing gas bubble entrapment from bulk cured room temperature condensation curable silicone compositions. The method comprising applying a predefined volume of a bulk cured room temperature condensation curable silicone composition bulk curable silicone composition onto or into a target substrate. The method further comprising at least initially curing the composition in an atmosphere having a relative humidity of X %, wherein X has a value in the range of 0<X≤40%, for a predetermined time or until no gas bubbles remain visible in the composition.

This disclosure relates to a method for reducing gas bubble entrapment from bulk cured room temperature condensation curable silicone compositions.

Room temperature condensation curable silicone compositions, generally cure via two different cure processes. One-part room temperature condensation curable silicone compositions are provided with a view to generating skin or diffusion cured silicone-based materials which may vary in nature from a loosely cross-linked gel to an elastomeric material. The skin or diffusion cure (e.g., moisture/condensation) takes place with an initial formation of a cured skin at the composition/air interface subsequent to the one-part room temperature condensation curable silicone composition, being applied on to a substrate surface. Subsequent to the generation of the surface skin the cure speed is dependent on the speed of diffusion of moisture from the sealant/encapsulant interface with air to the inside (i.e. the bulk or core), and the diffusion of condensation reaction by-product/effluent from the inside (bulk or core) to the outside (or surface) of the material and the gradual thickening of the cured skin over time from the outside/surface to the inside (bulk or core). These one-part room temperature condensation curable silicone compositions or formulations are typically available in one-part packages that are applied in layers that are no more than about 15 mm thick. Layers thicker than 15 mm are known to lead to uncured material in the depth of the bulk/core material, because the moisture is very slow to diffuse in very deep sections. They are generally cured using alkoxy titanium and/or alkoxy zirconium compounds i.e., alkyl titanates and/or alkyl zirconates as curing agents catalysing the cure process, with the former usually being preferred. Given the fact that such one-part room temperature condensation curable systems require air moisture to cure, their cure speed may be accelerated by increasing the level of relative humidity.

In contrast silicone compositions stored before use in two or more parts, are designed to initiate cure in the bulk or core (hereafter referred to as bulk) of the composition once the different parts are mixed together. This enables bulk cure to take place in compositions greater than 15 mm in depth. Such compositions tend to cure much quicker than diffusion cure processes as curing takes place throughout the bulk of the composition and as such is referred to as “bulk curable” or “bulk cured”. Whilst a skin may be formed at the air/composition interface during the cure process, the vast majority of the composition is cured in the bulk of the material and quickly becomes a cured solid throughout the entire mass. These multiple part compositions have traditionally been cured using e.g. tin or zinc metal-based catalysts such as dibutyl tin dilaurate, tin octoate and/or zinc octoate, however it has recently been identified that zirconates and particularly titanates may be utilised for bulk cure multi-part compositions when utilised in specified ratios with other ingredients, although the speed of cure of such compositions can still hinder their use in applications requiring fast cure and/or flip over times, i.e., the point where the material does not flow anymore.

That said, the increased speed of cure when using multi part compositions which, when mixed together are designed to cure in the bulk of the composition, can result in other issues being observed. For example, gas bubble formation can be a problem especially when using two-part compositions in a variety of applications such as for potting materials for electronics and or in the preparation of spacers for insulated glazing. This is particularly evident in cases when seeking to provide transparent or translucent cured materials e.g. if potting electronic materials or preparing “crystal clear” silicone molded parts for example to be used to produce spacers for insulating glass units. Key features of these molded parts are their optical properties, clarity and transparency. However, the presence of gas bubbles is detrimental and should be avoided because their presence leads to visual defects by diffracting light and avoiding a clear vision through the molded parts.

The presence of gas bubbles may be caused in several ways, for example, due to air entrapment, either during mixing or when being dispensed on to a desired target area/substrate/mold. Gas bubbles may also be generated in pre-cured compositions by the release of dissolved gases under pressure/during storage or can be formed through chemical reactions which take place during the cure process resulting in the generation of volatile compounds.

In the case of molded products such as spacers for insulated glazing units most gas bubbles contained in the silicone compositions are created during or after the multi-parts have been mixed together and dispensed into molds. Such bubbles will naturally migrate towards the silicone/air interface and break-up as long as the viscosity of the curing composition is sufficiently low. However, the speed of migration of the gas bubbles to the silicone/air interface is often too slow, given the speed of the bulk cure process, resulting in gas bubbles remaining trapped in the cured spacer leading to such visual defects.

The usual way in which gas bubbles are removed from silicone compositions when molding the composition into desired shaped products by e.g. compression molding, is to cover the mold with an air tight cover or lid and apply vacuum (suction) in the headspace in the mold between the upper surface of the composition and the inner surface of the cover during or after the composition is or has been dispensed into the mold. This may be referred to as defoaming or degassing but the technique is usually largely the same i.e. by the application of vacuum.

However, applying vacuum may cause excess degassing of gases dissolved in a silicone composition that has been dispensed into the mold. This may consequently actually cause swelling, foaming and/or potential overflow of the dispensed composition from the mold cavities and can ultimately cause more defects in the resulting molded product. For example, swelling created by the vacuum can result in material sticking to the walls of the cavity resulting in the presence of a larger meniscus when the gas has been removed than there otherwise would have been, which can lead to a decrease in the escape of gas bubbles naturally.

Furthermore, the use of vacuum can lead to the extraction of moisture from the bulk of the composition which can result in a significant reduction in cure speed or even prevent cure at all given the reliance on bulk curing for these sorts of compositions.

As such there is a desire to provide a vacuum-free method for minimising the presence of gas bubbles in bulk-cured molded silicone-based materials prepared by curing multi-part room temperature curable silicone compositions.

There is provided herein a method for reduction of gas bubble entrapment in bulk cured room temperature condensation curable silicone compositions, comprising applying a predefined volume of a bulk cured room temperature condensation curable silicone composition onto or into a target substrate and at least initially curing the composition in an atmosphere having a relative humidity of X % wherein X has a value in the range of zero is less than X which is less than or equal to 40% (0<X≤40%) for a predetermined time or until no gas bubbles remain visible in the composition.

Surprisingly, it was found that by enabling cure to at least commence at a low relative humidity of at most 40%, alternatively at most 35%, alternatively at most 30%, the presence of gas bubbles trapped in the cured silicone material after the completion of cure was significantly decreased.

The relative humidity of an air-water mixture is defined as the ratio of the partial pressure of water vapor in the mixture to the equilibrium vapor pressure of water over a flat surface of pure water at a given temperature. Relative humidity is normally expressed as a percentage (%); a higher percentage means that the air-water mixture is more humid. At 100% relative humidity, the air is saturated and is at its dew point. It is known that relative humidity can impact the cure of 1-part sealants. However, 2-part RTV systems are considered to be insensitive to relative humidity as the source of moisture is already contained in the system which allows the product to cure from the bulk. The relative humidity in the headspace herein may be determined and/or controlled using any suitable hygrometer such as a Medisana™ HG 100 Digital Thermo-Hygrometer from Medisana GmbH or a testo 623—Thermohygrometer from Testo SE & Co. KGaA.

Any suitable target substrate may be used, such as a mold containing one or more cavities into which the bulk cured room temperature condensation curable silicone composition is being molded during the process described above or an article that needs to be potted and/or encapsulated for electronics, photovoltaic, aesthetics and/or architectural use.

In a preferred embodiment the method as described above for reduction of gas bubble entrapment in bulk cured room temperature condensation curable silicone compositions, comprises:
(i) applying a predefined volume of a bulk cured room temperature condensation curable silicone composition onto or into a target substrate;
(ii) enclosing said composition with a cover, which cover has an inner surface such that a headspace is formed between the composition and the inner surface of the cover;
(iii) introducing a dry gaseous blanket into the headspace and reducing the relative humidity of X % in the headspace to a range of 0<X≤40 for a predetermined time or until no gas bubbles remain visible in the composition.

In one embodiment the method for the reduction of gas bubble entrapment described herein may be utilised for the reduction of gas bubble entrapment in bulk cured room temperature condensation curable silicone compositions, being cured in molds to produce cured silicone articles wherein step (i) comprises introducing a predefined volume of a bulk cured room temperature condensation curable silicone composition into a mold; and step (ii) comprises covering the mold with a lid/or cover having an inner surface, such that a headspace is formed between said composition in the mold and the inner surface of the lid.

In molding applications most gas bubbles contained in bulk cured room temperature condensation curable silicone compositions being molded are created after the multi-part compositions have been mixed together and after being dispensed in the mold. The resulting bubbles formed will naturally move towards the silicone/air interface and collapse upon reaching it so long as the viscosity of the curing material is sufficiently low to allow the gas bubble to move therein. However, in cases where, for example, a large number of gas bubbles are formed, or very small gas bubbles are present the degassing process is too slow to succeed completely before gas bubbles are entrapped in the cured product.

In step (iii) of the above the dry gaseous blanket may be dry air or dry nitrogen. The dry gaseous blanket may be introduced continuously or may be introduced in a one-off step entrapped in the headspace while the cover/lid is in place.

The atmosphere or dry gaseous blanket is maintained at a relative humidity of X where zero is less than X which is less than or equal to 40% (0<X≤40%), alternatively 0<X≤35%, alternatively 0<X≤30%, alternatively 0<X≤28%, alternatively 0<X≤25%, alternatively 2.5<X≤25%. It was surprisingly found that by maintaining the relative humidity of the headspace above the mold at a low level as defined above for a limited time, the number of gas bubbles trapped in molded products such as spacers for insulated glazing applications could be significantly reduced, and possibly completely eliminated leading to a fully transparent, gas bubble-free elastomer. The predetermined length of time will depend on the composition utilised but may be, for the sake of example, but not limited to, between several minutes and 72 hours, alternatively between 1 and 48 hours, alternatively between 2 and 48 hours, alternatively between 4 and 48 hours, but may be longer if desired or deemed necessary.

Preferably during the cure process, e.g. in step (iii) of the above preferred embodiment, the temperature is typically room temperature i.e. between 20 and 25° C. but may be up to 30° C., although this is not preferred, as elevated temperatures are likely to be counter-productive by accelerating cure and potentially causing additional presence of the unwanted gas bubbles.

After the bulk cured room temperature condensation curable silicone composition has undergone initial curing at a relative humidity of X % wherein X has a value in the range 0<X≤40% e.g. in step (iii) the temperature, the relative humidity or both the temperature and relative humidity may be allowed to increase which will as a consequence accelerate cure. It was surprisingly found that by maintaining the value of X in the desired ranges identified during step (iii) of the above preferred embodiment, the number of gas bubbles trapped in the resulting cured spacer could be significantly reduced, and possibly completely eliminated leading to a fully transparent, gas bubble-free elastomer which is allowed to cure under normal room conditions after the completion of step (iii).

The present disclosure provides a method of removing the gas bubbles whilst avoiding the need for a vacuum system which can cause more problems than benefits as discussed above. Hence, it may be said that the method herein is a vacuum-free method.

In one embodiment herein therefore the method for reduction of gas bubble entrapment in bulk cured room temperature condensation curable silicone compositions as hereinbefore described may form part of a process for making molded articles.

A method for the reduction of gas bubble entrapment in bulk cured room temperature condensation curable silicone compositions as hereinbefore described, may comprise:
(i) applying a predefined volume of a bulk cured room temperature condensation curable silicone composition into a mold;
(ii) placing a cover on the mold, which cover has an inner surface such that a headspace is formed between the composition in the mold and the inner surface of the cover;
(iii) introducing a dry gaseous blanket into the headspace and reducing the relative humidity in the headspace;
(iv) controlling the relative humidity (X) in the headspace within a range where, 0<X≤40% or alternatively one of the above alternate ranges, preferably below 35% relative humidity and at a temperature less than or equal (<) to 30° C. for a desired period e.g. for say 2 hours to 2 days depending on the cure speed of the bulk cured room temperature condensation curable silicone composition or until no gas bubbles are visibly left in the curing room temperature curable silicone composition in the mold; and
(v) subsequent to completion of the desired time period removing the lid and thereby enabling the bulk cured room temperature condensation curable silicone composition to cure under room temperature, pressure and relative humidity or if desired at an elevated temperature and/or relative humidity of e.g. up to about 80° C. and/or relative humidity of e.g. up to about 80%.

Alternatively there is provided a method for molding shaped silicone elastomeric articles from bulk cured room temperature condensation curable silicone compositions, comprising:
(i) introducing bulk cured room temperature condensation curable silicone composition onto a substrate or into a mold cavity, which composition is designed to flow sufficiently to conform to the predefined shape in the mold into which it has been introduced; and
(ii) enabling the bulk cured room temperature condensation curable silicone composition to cure in the predefined shape into which it was introduced to form a shaped silicone elastomeric article by controlling the relative humidity (X) within a range where, 0<X≤40% or alternatively one the above alternate ranges, preferably below 35% relative humidity and at a temperature less than or equal to (≤30°) C at a temperature below 30° C. more preferably below 25° C.;
(iii) Applying these controlled atmospheric conditions for a desired period e.g. from several minutes to 2 or 3 days dependent on the use, the thickness of the curing material etc. alternatively for less than or no more than 3 hours or preferably until all gas bubbles have left the shaped silicone elastomeric articles; and subsequently.
(iv) Allowing the shaped silicone elastomeric articles to cure at a temperature of up to about 80° C. and/or relative humidity of e.g. up to about 80%.

With the method described above, most gas bubbles contained in the composition after having been dispensed into a mold will naturally move up to the silicone/air interface and collapse upon reaching the surface as long as the viscosity of the curing composition is sufficiently low. However, in cases where, for example, a large amount of gas bubbles are formed, very small gas bubbles are present or even when there are gas bubbles adhering to the release film, the degassing process is too slow relative to the bulk curing process and consequently gas bubbles remain trapped in the subsequently cured article leading to a negative or impaired visual appearance.

In the above methods the resulting molded article may be a transparent spacer for use in insulated glazing. It has been standard practice for many years to form transparent units such as insulating glass units (IGUs) consisting of two, three, or more glass panes with each adjacent pair of panes spaced apart using a suitable spacer and sealant combination applied by way of an “edge seal” process. The edge seal process provides a means of spacing adjacent panes apart whilst also providing a seal extending around the periphery of the inner facing surfaces of the glass panes to define a substantially hermetically sealed insulating space between the glass panes. Whilst spacers may self-adhere to the glass, most do not, in which case, satisfactory adhesion of the spacer to the glass panes is conventionally provided by way of a primary sealant. The spacer and primary sealant combination is designed to be moisture, vapour and/or gas impermeable, to prevent moisture or water vapour entering and condensing in the inner cavity of the unit and, in case of a gas filled unit, avoiding escape of gas from the unit. The so-called “primary” sealant may be e.g., a “butyl sealant” such as a polyisobutylene rubber-based material which is utilised to bond non-self-adhesive spacers e.g., metal spacers to the glass panes and to employ a secondary sealant bonded to the panes around the spacer.

The vast majority of non-adhesive spacers, self-adhesive spacers, primary sealants and/or secondary sealants utilised in edge-seal systems are black, white or opaque or even otherwise coloured, thereby reducing the area of the insulating glass unit through which light may pass. However, recently there has been a desire to produce transparent spacers for IGUs particularly when vision through the IGU is important, e.g., commercial fridge applications. Incumbent solutions mostly use a rigid clear plastic such as a polycarbonate or polymethylmethacrylate (PMMA) spacer that is fixed onto the glass using a clear double-sided tape. However, silicone spacers have now been developed as described in WO2018160325 with much better adhesion durability than that of the aforementioned rigid plastic spacers due to their better flexibility and to the fact that the chemical adhesion of the silicone to the glass is maintained, even after prolonged periods of aging (e.g., high temperatures or hot water immersion).

Whilst these new 2-part titanate or zirconate (typically titanate) bulk cured room temperature condensation curable silicone compositions have proven to cure much faster than the diffusion cure titanate/zirconate catalyst containing compositions they are unsuitable for extrusion techniques because they are condensation curable thermosetting materials which cure slowly and which have gel points which are not reached for at least several minutes from the start of the cure process and indeed in some instances the gel point is not reached for several hours. For the avoidance of doubt by gel point we mean the time when tan delta (G″/G′) is 1 i.e., where G″ (the storage or elastic modulus in shear) and G′ (the loss or viscous modulus in shear) are equal. This represents the transition from a liquid to a solid material. Around this transition point the material is behaving as a viscoelastic material, which will deform differently according to the level of the stress that is applied to the material. Before the gel point, the material is very sensitive to any stress applied, which can induce flow thereof. Beyond the gel point a low stress applied will induce reversible deformation, i.e., the material will return to its initial position after the stress is removed. The gel point of a material may be determined using several alternative methods including, for the sake of example, by way of the tests in ASTM D4473-08 (2016). As a consequence, a new process described in PCT/US20/045706, published as WO2021030316, was developed, (the content of which is included herein by reference). This was designed to provide an alternative method of manufacture of such spacers avoiding the need for extrusion.

The 2-part titanate bulk cured room temperature condensation curable silicone compositions are typically flowable and self-levelling. For the avoidance of doubt a flowable room temperature curable silicone composition has a viscosity which is sufficiently low immediately prior to commencement of the cure process, to visibly flow under the influence of gravity and/or be even self-levelling. By structural resilience we mean the ability to hold its structural form in the absence of e.g., a mold or other form of support.

The method described in PCT/US20/045706, published as WO2021030316, provides a suitable route for the manufacture of molded, elongate silicone elastomeric articles from bulk cured room temperature condensation curable silicone composition which can be prepared using the method enclosed herein in one of our preferred embodiments. It is desirable to produce elongate silicone elastomeric articles with parallel sides, for example, to be used as spacers in insulating glass units (IGUs) which avoids the need to rely on an extrusion process. It is believed that the process described herein may be used to compliment the process described in PCT/US20/045706, published as WO2021030316, in that the process for delivering elongate silicone elastomeric articles from 2-part titanate catalysed bulk cure room temperature curable silicone compositions can be achieved in combination with the process herein to remove gas bubbles from the compositions as the cure process takes place. Without being tied to current theories, it is believed that the process described herein may inhibit the cure process during the period when the headspace is purged with the dry air or dry nitrogen and the relative humidity is reduced and that said inhibition enables gas bubbles in the molded composition to rise to the composition surface, e.g. the headspace/composition interface and collapse upon so doing, thereby achieving a gas bubble free molded product upon completion of cure.

Hence, the above method provides a means of producing shaped silicone elastomeric articles, especially elongate silicone elastomeric articles e.g., spacers, from bulk cured room temperature condensation curable silicone compositions, which may be flowable at the commencement of cure. The articles e.g., pre-cured spacers described in WO2018160325, are both self-adhesive and transparent and as such this method, when using compositions as described therein or similar compositions provides a means for the manufacture of self-adhesive transparent spacers, which once introduced into insulated glass units provide the viewer with an improved (better) viewing capability.

Hence, the ability to remove gas bubbles from molded compositions without the need for air suction methods using vacuum techniques during the cure process can be exemplified herein wherein step (i) of the process described above may be achieved as follows:
(i)(a) draping a film over a mold comprising two or more predefined shapes to establish an evacuatable volume between the film and each predefined shape in the mold;
(i)(b) applying suction to the evacuatable volume between a first predefined shape of the mold and the film to establish an at least partial vacuum within the evacuatable volume of said first predefined shape, such that the film forms a filmic inner lining conforming to the first predefined shape of the mold;
(i)(c) additionally, applying suction to the evacuatable volume between a second predefined shape of the mold and the film, which second predefined shape, is adjacent to the first predefined shape, to also establish an at least partial vacuum within the evacuatable volume of said second predefined shape and consequently also forms a filmic inner lining conforming to the second predefined shape of the mold;
(i)(d) sequentially repeating step (i)(a) to (i)(c) until each predefined shape in the mold has an at least partial vacuum within the evacuatable volume thereof and the film forms a filmic inner lining conforming to each respective predefined shape of the mold; and
(i)(e) introducing bulk cured room temperature condensation curable silicone composition onto the filmic inner lining conforming to one or more predefined shapes of the mold, which composition is designed to flow sufficiently to conform to the predefined shape in the mold into which it has been introduced.

Upon completion of this version of step (i), step (ii) and step (iii) of the process herein are undertaken, namely:
(ii) enclosing said composition with a cover, which cover has an inner surface such that a headspace is formed between the composition and the inner surface of the cover;
(iii) introducing a dry gaseous blanket into the headspace and reducing the relative humidity in the headspace for a predetermined time or until no gas bubbles remain visible in the composition. The method will take place whilst enabling the bulk cured room temperature condensation curable silicone composition to cure in the predefined shape into which it was introduced to form a shaped silicone elastomeric article.

When step (i) of the present disclosure is undertaken using (i)(a) to (e) as described above, most gas bubbles contained in the spacer after the composition is mixed and dispensed into the mold will naturally migrate towards the silicone/air interface and collapse upon reaching same as long as the viscosity of the curing composition is sufficiently low. However, in cases where, the present invention is not utilised if, for example, a large amount of gas bubbles are formed or very small gas bubbles are present or even gas bubbles adhering to the release film, the migration of the gas bubbles may be too slow resulting in gas bubbles remaining trapped in the cured spacer leading to a negative visual defect.

The 2-part condensation cure composition used to produce transparent spacers herein is described in more detail below but despite using titanate and/or zirconate catalysts cures from the bulk like other known 2-part condensation cure systems which can be used to prepare potentially thicker elastomeric parts than normally achieved by 1-part condensation cure systems. However, because they are not based on typical organotin catalysts, cure times are comparatively longer than typical 2-part condensation cure compositions or addition cure silicone compositions. Despite the longer cure times gas bubbles were still found to remain trapped in the resulting cured silicone elastomer. It was found that the acceleration of cure kinetics, however, induces an issue related to the retention of gas bubbles in the spacer during cure.

During the spacer production trials it was found that gas bubbles were generated. This was thought to occur as a result of gases released during the cure process and/or due to air entrapment. Such bubbles could remain trapped in the spacer, particularly when cure was taking place under humid conditions (i.e. a relative humidity (RH) of greater than (>) 40%) and/or when cure took place at a temperature greater than room temperature. Often, a few small gas bubbles remained trapped in the meniscus (top of the spacer). It was found that the optimum temperature for the cure process whilst minimising bubble generation was between 20 and 25° C. Preferably the relative humidity during dispensing was the standard relative humidity of the laboratory which could be as high as 80% but was typically 40 to 50% and the preferred relative humidity during the initial period of the cure process was between 10 and 40% humidity, preferably between 10 and 30% relative humidity, alternatively between 15 and 25% relative humidity. It was found that after following the initial cure process it was possible to adjust temperature and/or humidity to higher levels to accelerate the cure whilst preferably still remaining within the temperature and humidity range described above. It is preferred that the head space had sufficient ventilation to enable the removal of by-products such as small amounts of alcohol (methanol and butanol) will be released during the curing process. It was found during visual inspections for bubbles that, spacers prepared using the process described herein had far less, if any, bubbles trapped in the cured products such that the resulting spacers could be used as a clear spacer when the spacer is placed in an insulating glazing (IG) unit. Furthermore, such cured materials, given the composition is suitable the spacer can be a crystal clear product when visible when the spacer is placed in the IG unit.

Based on the above results it was hypothesized that the silicone composition at the air/liquid (composition) interface would undergo a faster cure than the bulk and form a cured skin within 30 min-2 hours, thereby trapping the last remaining gas bubbles. Preventing this skin formation was therefore deemed necessary (a requirement) to ensure a successful spacer production regardless of the humidity levels in the environment. It was shown that by covering the mold with a plastic sheet and flushing the headspace with dry air in order to reach a relative humidity of X % wherein X has a value in the range 0<X≤40% most spacers were gas bubble-free.

The mold, as used in the embodiment described above to exemplify the present disclosure, comprises two or more predefined shapes, e.g. a series of elongate parallel channels. For example, in one embodiment, when the intended end use for the resulting cured articles is as spacers for insulated glazing units (IGUs), the parallel channels are formed by walls which are of a height greater than that desired for the molded articles, e.g., at least 5 mm higher than molded articles. The walls may be of any suitable construction e.g., they may have rounded or sharpened edges. Hence, when a lid is placed on top of the mold a headspace is formed between the top of the composition at the gas/composition interface and the inner surface of the lid which enables dry gases to be introduced and relative humidity to be controlled in the headspace, allowing gas bubbles to migrate to the surface of the composition and consequently collapse providing a transparent product with no gas bubbles evident.

The shaped silicone elastomeric articles can be designed to be of any desired shape and size, i.e., in order to be suitable for their end use. In the case of elongate silicone elastomeric articles such as spacers for IGUs they may for example, be 7.5 to 25 mm wide, alternatively 10 mm to 25 mm wide and 5 to 25 mm deep, alternatively 10 to 25 mm deep, alternatively 10 to 20 mm deep. The length of the elongate silicone elastomeric articles can be anything up to the full length of the channel in which it is being molded. Indeed, if required, after the completion of cure, the length of the article may be cut to size or cut into multiple different lengths. However, for example the article may be e.g., from 0.5 to 3 m in length, alternatively from 1 to 2.5 m in length.

Each of the two or more predefined shapes in the mold contain a series of openings designed to enable an at least partial vacuum to be established by evacuating air and/or other gases from the respective evacuatable volume created by draping the film over the respective predefined shape in the mold. The openings may be of any suitable cross-section but are typically of a circular, square or rectangular cross-section, alternatively a circular cross-section. When the holes have a circular cross-section, they may have a diameter of from 0.5 to 3 mm, alternatively 0.5 to 2 mm.

In one embodiment when the two or more predefined shapes are a series of elongate parallel channels in the mold, each parallel channel having a base and first and second parallel side walls at an angle of approximately 90° to the base, the openings are positioned at a set distance apart along one or both side walls and/or in the base of the channel. Alternatively, the openings are positioned a set distance apart in the corner(s) between the base and the first side wall and a set distance apart in the corner(s) between the base and the second side wall. The positioning of said openings are important as they ensure that the film conforms to the shape of the mold once suction is applied to the evacuatable volume. Hence, in one alternative, the openings may be, or are equidistantly distributed along the length of each channel of the mold to enable a consistent vacuum to be drawn along the whole length of the respective channel.

The suction applied causes a vacuum to be drawn through the openings to evacuate gases from the evacuatable volume of the pre-defined shape (e.g., channel) and consequently draws the film into the predefined shape (e.g., channel). The film used is designed to conform to the shape thereof to create a filmic inner lining in the respective predefined shape, e.g., channel. The vacuum drawn in any one predefined shape may be drawn independently from vacuum in each other predefined shapes in the mold. This may be achieved by having an on/off switch for vacuum to be operated for each individual channel. The process is designed to ensure the inner lining doesn't get damaged or stretched in order to ensure consistency of spacer shape in the mold once the composition provided has cured.

In one embodiment the mold may comprise a single unit having a mold part and a vacuum part wherein the vacuum part is connected to a suitable vacuum generator as described above and is designed to draw a vacuum through the openings in the respective predefined shape. Alternatively, the mold part and the vacuum part may be two inter-connectable parts which, in use, are engaged in order for a vacuum to be applied into the evacuatable volume between the film and a predefined shape but enabling the vacuum part to be disconnected as and when the vacuum is deemed no longer required. Hence, the vacuum part may be detachable e.g., such that whilst the mold is being used to retain and mold the final article during the lengthy cure period, the vacuum part may be reused with additional molds which may be fixably placed on top of the vacuum part with the openings aligned thereto to enable a vacuum to be drawn as described elsewhere.

The film utilised herein to form the filmic inner lining in the preformed shapes of the mold may be any suitable film for such a purpose. Films were selected based on three main criteria:
(i) the ability to conform to the predefined shapes in the mold via the method used herein without being damaged or stretched;
(ii) the avoidance for the need to heat the film to gain adequate conformity thereof to the predefined shapes;
(iii) being releasable from the resulting silicone elastomer article generated once the composition has cured (post-cure).

In one embodiment the film material used may be chosen with respect to its “wettability” by the bulk cured room temperature condensation curable silicone composition to be introduced into the predefined shapes, in that it is desired for the composition to have a minimal meniscus when the film is functioning as an internal layer in the mold, i.e., when the composition has been introduced into the mold and allowed to flow under gravity into position the composition/air interface is approximately horizontal. Suitable films of this type include, for the sake of example, polyethylene (PE) especially low-density polyethylene (LDPE), polyethylene terephthalate (PET), polytetrafluoroethylene (PTFE) and fluorinated ethylene-propylene (FEP). If desired said films may be modified to incorporate additives such as, for the sake of example, slip additives and/or anti-block agents. By wettability we mean the ability of a liquid to maintain contact with a solid surface, resulting from intermolecular interactions when the two are brought together.

The above were found to be suitable because these films did not have a negative impact on the adherence properties of the spacer when applied on glass. It was found that some films depending on
(i) their film surface functional groups,
(ii) different surface species or
(iii) different orientation of the surface species could impact how the spacer adheres on glass post-cure. The film may be a release film.

The film is preferably highly flexible and has a film thickness of from 10 to 100 μm, alternatively from 20 and 70 μm (thinner films tend to crinkle whereas thicker films do not conform well onto surface).

When each predefined shape in a mold is an elongate channel as previously described, each channel in a mold has two ends. Both ends may be fixed in place or may alternatively be open-ended or one end is fixed in place and the second end is open-ended. Whichever is the case, a slidable guide may be utilised in order to vary the length of the elongate predefined shape (e.g., channel). It may also act as a guide for the film to ensure it retains its desired position because it was found to be a significant challenge to maintain the position of the film in each respective predefined shape of the mold to avoid stretching of the film and/or non-conformity thereof to the predefined shape resulting in causing a negative effect on the shape of the elongate silicone elastomeric articles resulting from bulk cured room temperature condensation curable silicone composition in the predefined shape (e.g., a channel). The film is required to form a filmic inner lining which conforms to the shape of each predefined shape of the mold. The slidable guide has also been found, when in use, to enable vacuum to be pulled more consistently/efficiently within its respective evacuatable volume. When multiple elongate silicone elastomeric articles of the same length are required the slidable guide may be provided in a comb design (depicted in FIG. 3 of PCT/US20/045706, published as WO2021030316 and incorporated herein by reference) used to act as the channel end and guide for the film in multiple adjacent channels in a single mold. Preferably the slidable guides are a tight fit in each channel therefore acting as a barrier to prevent the escape or leakage of bulk cured room temperature condensation curable silicone composition, especially if/when flowable, prior to curing sufficiently from its dimensionally unstable initial form. If the slidable guide is not deemed sufficiently liquid tight a plug of suitable material may be inserted between the guide, when inserted in the mold, and the bulk cured room temperature condensation curable silicone composition once added into a predefined shape of the mold to avoid leakage of the bulk cured room temperature condensation curable silicone composition therefrom during the early stages of cure when potentially flowable. The plug may be made from e.g., a fast curing 1-part silicone sealant, foam plugs preferably having closed cells and other suitable materials such as putty. The plug is introduced onto the filmic inner lining, prior to introduction of the bulk cured room temperature condensation curable silicone composition, being used to seal the ends.

In use, a film is initially draped over the mold to establish an evacuatable volume between the film and each predefined shape, e.g., a channel in the mold. The film is then drawn into each predefined shape in the mold, conforming to the mold by suction through the openings caused by a vacuum generator resulting in the film becoming a filmic inner lining in each predefined shape in the mold conforming to the shape of the predefined shape. The use of a film in this way prevents elastomer adhering to the walls of the mold during cure and consequently preventing damage/mechanical failure of a shaped silicone elastomeric article upon removal from the predefined shape. The film may also be utilised to remove the resulting shaped silicone elastomeric article or a partially cured molded article out of the predefined shape in which it has been molded.

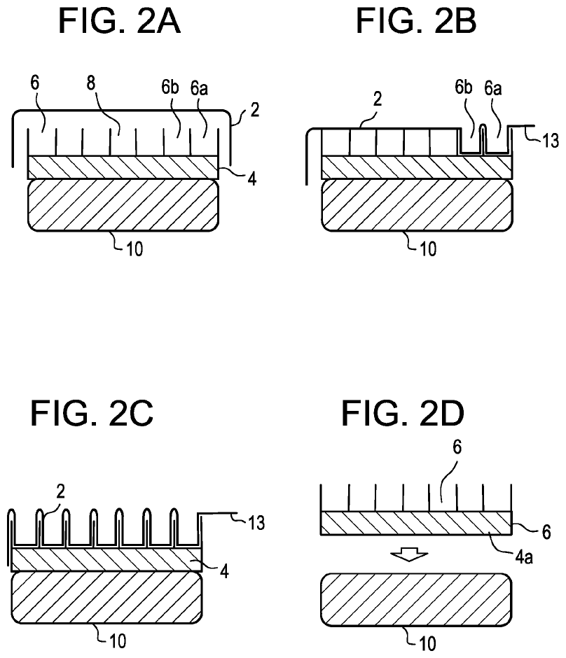

In one embodiment the film initially draped over the mold is fixed in place at one edge of the mold such as is depicted depicted in FIG. 2 of PCT/US20/045706, published as WO2021030316 and incorporated herein by reference). When the film has been clamped, the first channel to which a vacuum is applied is that adjacent to the fixing means such that when suction occurs through openings in the channel discussed above, the film is drawn into the aforementioned channel to form a filmic inner lining which conforms to the shape thereof. Once this is complete in said first channel the method is repeated in the adjacent channel until suction is applied in each channel and the film is acting as a filmic inner lining conforming to the shape of each channel. Once this has been completed the bulk cured room temperature condensation curable silicone composition may be introduced into each channel. The fixing of the film may be undertaken by clamping the film:
a. At one extremity of the mold, or
b. Along the wall of a channel not located near the extremity of the mold.
   Preferably, clamping is done by use of a single clamping means along the whole length of the mold or in the case of a series of elongate channels along the whole length of said first channel. Alternatively, a plurality of clamping means may be used spaced apart along the length of the first elongate channel, however, the former is preferred.

In one embodiment the film used for molding the elongate elastomeric articles can be used as packaging of the silicone molded part.

The bulk cured room temperature condensation curable silicone composition used herein to form elastomeric articles may be any suitable 2-part room temperature curable silicone composition which relies on a titanate cure catalyst. Such a composition is preferably designed to at least substantially cure in bulk and preferably does not contain any inorganic reinforcing filler. Such a composition, given the lack of filler, may be flowable and self-levelling at the commencement of the cure process.

The bulk cured room temperature condensation curable silicone composition may comprise:
(i) at least one condensation curable silyl terminated polymer having an average of at least 1.5, alternatively an average of at least 2 hydrolysable and/or hydroxyl functional groups per molecule;
(ii) a cross-linker selected from the group of
   silanes having at least 2 hydrolysable groups, alternatively at least 3 hydrolysable groups per molecule group; and/or
   silyl functional molecules having at least 2 silyl groups, each silyl group containing at least one hydrolysable group.
(iii) a condensation catalyst selected from the group of titanates and zirconates; characterized in that:
the molar ratio of hydroxyl groups to hydrolysable groups is between 0.1:1 to 4:1
and the molar ratio of M-OR functions to the hydroxyl groups is from 0.01:1 and 0.6:1, where M is titanium or zirconium and R is an alkyl group.

The composition is stored in two-parts prior to use to avoid premature curing and then the two-parts are mixed in a predefined ratio (e.g., a weight ratio) immediately prior to use. As previously indicated, immediately after mixing the resulting viscosity of the composition may be sufficiently low for the composition to be flowable. For example, the part A of the composition may be merely a 13,500 mPa·s (at 25° C.) silanol terminated polydimethylsiloxane and part B of the composition or cure package comprised 100 weight parts of a 2,000 mPa·s trimethoxysilyl terminated polydimethylsiloxane (at 25° C.) and 0.3 weight parts of tetra-n-butyl titanate, per 100 weight parts of said trimethoxysilyl terminated polydimethylsiloxane. Viscosity may be measured using a rheometer such as an Anton-Paar MCR-301 rheometer fitted with a 25 mm cone-and-plate fixture and operated at 25° C. or if desired using a Brookfield™ rotational viscometer using Spindle (LV1-LV-4) and adapting the speed according to the polymer viscosity taken at 25° C. unless otherwise indicated.

Cured materials were prepared by mixing the two components of the composition together in a Base: curing agent weight ratio of 2.5:1 after mixing in a speed mixer on 4 occasions, in each case for a period of 30 seconds at a speed of 2300 rpm. In the present disclosure such a composition once mixed as described is introduced into the predefined shapes in the mold lined with the film.

The bulk cured room temperature condensation curable silicone composition may be gunnable, i.e., it is introduced manually or otherwise into each channel by application of a sealant gun. In the event the composition is introduced by means of a robotic or other automated system the operator thereof can set the exact amount of the composition to be introduced into each channel to ensure that each molded article is identical or substantially identical. This is particularly the case when the composition is flowable and as such will flow/settle under gravity into the shape of the mold. In order to avoid applying tension and stretching the film, the applied film is sucked in the mold with vacuum and positioned channel by channel. This ensures that even if vacuum is cut the film can remain in place and the molded article can retain its intended shape. In case the mold is made of two different parts, place the upper part of the mold on the bottom part (base) and lock it to ensure there will not be leaks. Some molds (e.g., PVC) can be in 1 piece with the top part being fixed on the base. In that case the two-parts are always assembled. Prior to use the mold is placed on a horizontal surface to ensure the bulk cured room temperature condensation curable silicone composition, once added is distributed evenly with a view to obtaining an elastomeric article of a standard thickness along the whole length of the channel.

When this composition is utilised to produce elongate spacers for insulating glazing units, the resulting spacers prepared via curing in the aforementioned molds must have two substantially parallel or parallel sides, preferably of a defined length, width and depth to concur with the dimensions required for the spacer in the insulated glazing unit and/or a combination thereof. For this to be achieved, the two or more predefined shapes in the mold are usually in the form of a series of elongate parallel channels. The film which is initially draped over the series of elongate parallel channels is required to be drawn into each predefined shape to form a filmic inner lining conforming to the shape of the channel. The mold is designed so that vacuum is applied in a manner which avoids damaging or stretching the film which may cause deformation of an elastomeric article molded therein. Deformation can occur if, for example, the film does not conform exactly to the predefined shape in a mold prior to introduction of the room temperature curable silicone composition therein.

It was determined that this is best achieved, given the desire to avoid damaging or stretching the liner during preparation, by applying the vacuum sequentially as described above i.e., in the case of a mold with two predefined shapes in a first predefined shape and then when the film has conformed to the shape of the first defined shape, maintain the vacuum in the first shape and commence the vacuum in the walls of the second defined shape in the mold. This means the film can slide/glide into a position in the second defined shape to form a filmic inner lining conforming to the shape of the second defined shape without damage/stretching of the film conforming to either or both defined shapes.

Hence, when the two or more predefined shapes in a mold are a series of elongate parallel channels, say, for example, a series of seven channels with channels being numbered from one to seven sequentially from right to left in the mold, then the vacuum is first pulled in channel one or channel seven. For the sake of simplicity, it is assumed that vacuum is first pulled in channel one. As the vacuum is pulled the film draped over the mold is drawn into channel one to form a filmic inner lining conforming to the shape of channel one. Once this is completed satisfactorily, the vacuum in channel one is maintained and the vacuum in channel two, adjacent to channel one is commenced and the method is repeated until the film is satisfactorily positioned in the channels one and two and then the method is repeated for channels three to seven sequentially such that when the vacuum is pulled in channel seven the vacuum is being maintained in the preceding six channels and the film is conforming to the shape of each of the respective channels. Once the film has been brought into conformance with each channel a selected bulk cured room temperature condensation curable silicone composition is introduced into each channel in any order in the mold.

Using this sequential application of vacuum in the “channel by channel” approach ensures that even if vacuum is cut once the film is in place as a filmic inner lining of each desired shape in the mold, the film remains in place conforming to the predefined shapes in the mold.

In the method described herein the following steps might be undertaken:—
(i) Provide a film of suitable dimensions. It should be of proportions suitable to easily form a filmic inner lining to all predefined shapes in the mold without the need for stretching or damage so that it may easily conform to the shape of all the predefined shapes. Clamp the film e.g., on the side of the first predefined shape into which vacuum will be applied.
(ii) In order to avoid air leaking via the two open extremities of the channels when vacuum is drawn, comb-like tools may be utilised, if so one may be placed at each end of the channels in close contact with the film thereby having the dual role of being a film guide but also closing any air gaps which could negatively affect the positioning of the film and drawing of the vacuum.
(iii) Turn on the vacuum generator e.g., a pump or Venturi and open a valve in said vacuum system such that suction is only applied to the first predefined shape in the mold (i.e., first channel). Once the suction commences the film is drawn into the predefined shape to form a filmic inner lining which may then be checked for any wrinkles or other defects with a view to ensuring said first predefined shape is ready for introduction of the bulk cured room temperature condensation curable silicone composition.
(iv) Once satisfied the valve in the vacuum line opening into the adjacent second predefined shape in the mold (e.g., channel) is also opened and the above step repeated. The same is then completed sequentially until all the predefined shapes (e.g., channels) have a vacuum drawn and a respective filmic inner lining conforming to the shapes thereof.
(v) If the aforementioned comb-like tool is considered not to be sufficiently well fitting in the channels to prevent the bulk cured room temperature condensation curable silicone composition from leaking out of the channel into which it is supplied, a plug of suitable material, e.g., a fast curing 1-part silicone sealant, foam plugs having closed cells and other suitable materials such as putty.
(vi) Subsequent to the above the bulk cured room temperature condensation curable silicone composition is introduced into the predefined shapes having filmic inner linings in the mold. The bulk cured room temperature condensation curable silicone composition is usually stored in two-parts prior to use to avoid premature commencement of the cure process. The two-parts, typically referred to as part A and part B are mixed together in the required weight ratio, using a suitable mixer.
(vii) Once the bulk cured room temperature condensation curable silicone composition has been mixed it is dispensed into the predefined shapes in the mold;
(viii) A lid is then placed over the mold such that a headspace is produced in each cavity between the gas/composition interface and the inner side of the lid and each headspace is flushed with dry air of dry nitrogen and the relative humidity of X % wherein X has a value in the range 0<X≤40% in the headspace is maintained as measured by a suitable hygrometer such as a Medisana™ HG 100 Digital Thermo-Hygrometer from Medisana GmbH or a testo 623—Thermohygrometer from Testo SE & Co. KGaA, for a predefined period which can be from minutes to several hours depending on the thickness of the molded articles being produced or alternatively the headspace may be maintained in place until all visible gas bubbles in the curing composition have disappeared. The lid can then be removed allowing for the bulk cure of the bulk cured room temperature condensation curable silicone composition to continue at room temperature, pressure and/or relative humidity until fully cured unless there is a desire to accelerate cure by increasing at least the temperature and/or relative humidity.

The composition is left to cure in the mold until it is deemed to have sufficient mechanical strength to maintain its shape without the need of the mold any longer. This period will depend on the content of the composition being used to make the elastomeric articles but for a composition that cures over say about one week the curing composition is typically left in the mold for 1 to 4 days, alternatively 1.5 to 3 days at room temperature.

After this period the partially cured material may be removed from the mold whilst retaining it in the film and the cure process is allowed to continue for as long as required and/or deemed necessary, again at room temperature.

Subsequent to completion of the cure process the resulting elongate elastomeric articles may be packaged and shipped for end use.

As previously discussed articles prepared by the above described process are suitable as spacers in insulated glass units. To be suitable for use as spacers in insulated glass units the elongate articles need to have two at least substantially parallel sides and as such an alternative process has been developed which is suited for low viscosity compositions requiring extended periods of time for curing. The provision of such clear spacers can significantly improve the viewing capability for a person e.g., looking into a display unit such as a fridge. It is important that the spacer is in good contact with the glass windows as malformed rounded shapes will not adhere properly to the glass.

A typical spacer is designed to keep two panes of glass apart and in this disclosure, there is a strong adhesive bond between each pane of glass and the spacer. In many warm edge type sealing solutions, a primary sealant is required to adhere the spacer to a glass substrate. In the present case, such sealants may not be required.

If the shaped silicone elastomeric articles resulting from the method as described herein may be sufficiently tacky to the touch given the presence of excess hydrolysable groups for physical adhesion to occur when the substantially cured or fully cured silicone-based material is brought into contact with a substrate surface. However, if the level of adhesion is not deemed strong enough the substrate may be pre-treated to enhance adhesion between the shaped silicone elastomeric articles produced from the process herein.

The method described herein will now be described in connection with one or more embodiments together with the Figures appended hereto. For the avoidance of doubt discussion with respect to any one particular embodiment or associated feature is not intended to be limiting thereto. The reader will appreciate that there are nunerous variations and equivalents that will be made apparent from the discussion that follows. Those variations and equivalents are intended to be encompassed by the scope of the present invention as if described herein.

There follows a brief description of the figures in which:

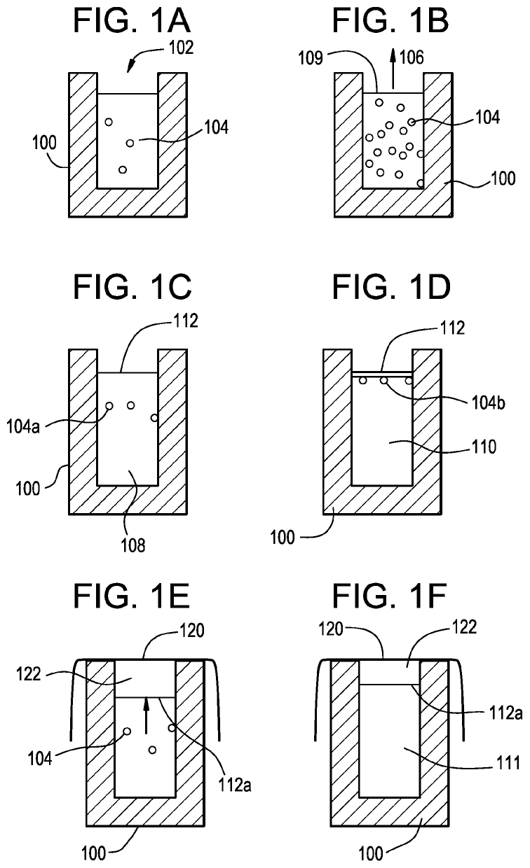

FIGS. 1A and 1B depict the formation of gas bubbles when a bulk cured room temperature condensation curable silicone composition in the form of a 2-part titanate curable silicone composition is mixed and introduced into a mold and the general migration of gas bubbles to the composition/air interface; in some cases, gas bubbles are formed in the composition after the dispense due to chemical reaction and/or degassing of dissolved gases.

FIGS. 1C and 1D depict gas bubble entrapment when the composition has cured and not all gas bubbles have migrated close enough to the composition/air interface in the mold;

FIGS. 1E and 1F depict the difference from 1c and 1d after using the process disclosed herein.

FIGS. 2A to 2C depict an embodiment of the disclosure herein following the stages involved in conforming the film into predefined shapes in a mold prior to introduction of the 2-part composition into the mold; and

FIG. 2D depicts a two-part mold.

Whilst each predefined shape may be the same or different for the sake of the following description of the Figures, each predefined shape is an elongate channel in a mold having a rectangular cross-section. The mold contains a plurality of these channels which are parallel to each other and which are designed to produce elongate spacer materials for use in e.g., insulating glazing. It will be appreciated that such a system is merely for example. In FIG. 1A there is depicted a mold (100) and the introduction (102) of a mixture of a two-part silicone composition from a 2-part mixer and dispensing machine (not shown), The introduction of the curable composition into the mold (100) typically generates gas bubbles (104) in the composition.

FIG. 1B depicts migration of gas bubbles created during mixing a dispensing of the mixed two-part composition (104) in direction (106) towards the air/composition interface (109). The majority of gas bubbles are usually able to migrate to interface (109) and subsequently collapse and gradually the composition in mold (000) contains less and less of the gas bubbles generated.

However, as depicted in FIG. 1C as the composition cures via the “in bulk” process the viscosity of the bulk material (108) increases slowing down gas bubble migration and gradually preventing gas bubbles (104a) reaching the surface of the air/composition interface (112). Eventually as shown in FIG. 1D the whole of the composition introduced into mold (100) including at the air/composition interface (112) is cured (110) entrapping the residual gas bubbles (104b) left within the cured matrix in mold (100).

Residual gas bubbles present in the body of the cured material (110) create visual issues, particularly if the cured molded articles is designed to be transparent or even “crystal clear”. FIGS. 1E and 1F depict the improvement provided by the disclosure herein. In FIG. 1E after the composition has been introduced into the mold (100) a lid (120) is placed over the top of the mold (100) forming a headspace (122) between the air/composition interface (112a) and the inner surface of lid (120). The headspace is purged with dry air or dry nitrogen and the relative humidity is controlled using a suitable hygrometer (not shown). Headspace (122) is maintained whilst all residual visible gas bubbles (104) migrate to the composition/air interface (112a) and collapse upon breaching the surface thereof. FIG. 1f shows the result of having the dry gas and reduced relative humidity in the headspace (122) in that all gas bubbles created during mixing and introduction of the composition into the mold can be removed over a pre-defined time period lid (120) is kept in place. Once no residual gas bubbles remain in the curing composition (111), lid (120) may be removed and the composition can be allowed to cure in the normal manner or cure may be accelerated by increasing the surrounding temperature and/or relative humidity.

In one embodiment herein step (i) of the process may be carried out as depicted in FIGS. 2A, 2B and 2C which depict the stages and apparatus involved in conforming a film (2) to form a filmic inner lining in a series of channels (6) in a mold (4) and then introducing a bulk cured room temperature condensation curable silicone composition which may be flowable at commencement of cure, in the channels (6) of mold (4) previously lined with the film (2). The bulk cured room temperature condensation curable silicone composition may have an extended cure time of at least several hours but typically several days, in the channels (6) previously lined with the film (2).

Initially as can be seen in FIG. 2A, a film (2) is draped over mold (4) comprising, in the present example, seven channels (6) to establish an evacuatable volume (8) between the film and each channel (6) in the mold (4). The channels may, for the sake of example be 2 m long, 12.5 mm wide and 18 mm deep. A series of holes (not shown) are provided in the side walls, corners and/or base of each channel (6). Each hole is linked to a vacuum system (10) for drawing a vacuum in the respective channel (6) which is intended to draw the film (2) into the channel to form a filmic inner lining in the channel (6). The vacuum system (10) is designed so that a vacuum may be drawn in each channel independent of whether or not a vacuum is being drawn in one or more other channels. This may be achieved by having an individual vacuum system for each channel but is preferably operated by having a single vacuum system and a switchable valve designed to control the vacuum drawn in each channel independent of the other channels.

The holes are dispersed across each channel in a pattern designed to ensure the film (2) is made to conform to the walls of the predefined shape without damage to the film (2), which as discussed previously might lead to the cure of spacer units of damaged or incorrect dimensions.

As is seen in FIGS. 2B and 2C the film (2) is clamped to one edge of the mold (4). Preferably, a bar (13) is fixed along the whole length of the first channel, as depicted by bar (13) using approximately equidistant clamps (12) (not shown).

In use, after the film (2) has been draped over the mold (4) and clamped at one edge, suction is initiated in the channel (6a) adjacent to the clamped edge causing the evacuatable volume (8) in said channel (6a) to be evacuated and film to be drawn into the channel (6a). Once the film is lining channel (6a) to the satisfaction of the operator, the suction is initiated in the next adjacent channel (6b) i.e., the second closest to the clamping means (12, 13) and adjacent to channel (6a), whilst maintaining the vacuum in channel 6a. The process is repeated until the film (2) is lining both channels 6a and 6b to the satisfaction of the operator after which the vacuum in the next channel is initiated and the process repeated. This happens e.g., in FIGS. 2B and 2C sequentially with respect to each channel (6) from right to left of the picture until the vacuum has been applied in all channels (6) and the film (2) is forming a filmic inner lining in each channel (6) conforming to the shape of its respective channel (6) to the satisfaction of the operator (FIG. 2C) at which point in time the bulk cured room temperature condensation curable silicone composition may be introduced into the mold (4) and allowed to cure.

In one embodiment as depicted in FIG. 2D, the mold (4) may be in two separable parts a mold part (4a) and a vacuum part or unit (10) such that while one mold (4a) is being used solely to shape bulk cured room temperature condensation curable silicone composition during the curing process of several hours to several days, it can be detached from the vacuum unit (10) providing application of suction is no longer required. This therefore enables the vacuum unit (10) to be reused to line a further mold (4a) in the manner described above. It was found particularly suited to utilise this embodiment when the mold/vacuum unit was made from metal, whilst when substantially manufactured in plastic the mold unit was preferably a single unit.

As discussed in more detail in PCT/US20/045706, published as WO2021030316, (incorporated herein by reference), it was found that, given the mold used in the process of introducing the composition described in conjunction with FIGS. 2A to 2D, the mold (4) comprises a series of adjacent, parallel channels (6), the introduction of a “tooth” from a comb like tool at each end of each channel (6) was advantageous. This comb like tool (seen in FIG. 3 of PCT/US20/045706, published as WO2021030316 and incorporated herein by reference) functioned as both a guide for the film (2) to prevent damaging the film (2) during the lining stage, but the teeth thereof also acted as an end means causing an improved/consistent vacuum to be drawn in each channel (6) as and when required. The comb-like tool may be made from any suitable material but is preferably non-stick to the cured silicone elastomer end-product and as such is preferably made from e.g., polytetrafluoroethylene (PTFE), polyvinyl chloride (PVC), low density polyethylene (LDPE) or even from metals such as steel or aluminium.

In use one tooth from the comb-like tool is inserted into the mold (4) at the end of each channel (6) prior to the introduction of any vacuum to any channel (6). It was found that whilst the comb-like tool was beneficial as a guide and/or as an effective end of each end of the channel (6), thereby defining the length of the elongate elastomer, once the composition has cured, that the teeth were not necessarily sufficiently well-fitting to prevent leakage of room temperature curable silicone composition from the mold (4) during early stages of the cure process when it does not have sufficient structural resilience to maintain the shape of the channel if removed therefrom. Any suitable means may be utilised to prevent said leakage, however, it was found that one simple methodology was to introduce a plug of disposable fast curing one-part sealant between tooth of tool (16) and the subsequently introduced bulk cured room temperature condensation curable silicone composition.

Subsequent to the above, the bulk cured room temperature condensation curable silicone composition may be introduced into the predefined shapes, i.e., channels (6) in the mold (4). The bulk cured room temperature condensation curable silicone composition is usually stored in two parts prior to use to avoid premature commencement of the cure process. The two-parts, typically referred to as part A and part B are mixed together in the required ratio, usually in a suitable two-part mixer suitable to mix low viscosity liquids (not shown), e.g., a Conti Flow Vario 2-component Mix and dispense system from Reinhardt-Technik GmbH of Kierspe Germany or a Graco EFR 2-part dispensing pump from Graco Inc. of Minnesota, USA. The chosen two-part mixer is suitable to mix part A and part B at a predefined weight ratio through a disposable static or dynamic mixer.

Once the room bulk cured room temperature condensation curable silicone composition has been added to each channel (6) and has been allowed to self-level, where appropriate, vacuum may be stopped. Referring to both FIGS. 1 and 2, a lid/cover (120) is then place over the mold to form an individual headspace (122) in each cavity of the mold between the inner surface of the lid/cover (120) and the composition/air interface. Once in place a dry gaseous atmosphere is provided by flushing the headspace with dry air or dry nitrogen or the like and a suitable hygrometer (as previously discussed) is inserted therein to measure the relative humidity. Alternatively, the hygrometer may be periodically inserted into the headspace to measure the relative humidity. When the composition is transparent and is intended for the preparation of a transparent cured product, preferably the lid/cover is also transparent so that the presence/absence of gas bubbles therein can be periodically observed. The time period required for all gas bubbles to be removed will vary depending on the compositions being cured. It was found that the lower the relative humidity in the head space the faster gas bubbles were removed and as such whilst the headspaces in each cavity of the mold may be maintained for a set predefined period, if preferred the headspace s may be maintained at a low relative humidity until all gas bubbles have disappeared from the curing composition when possible through visual inspection.

Once sufficient/all gas bubbles in the curing composition are deemed to have been removed the cover/lid may be removed and the bulk cured room temperature condensation curable silicone composition left to cure in the mold for 1 to 3 days until it has sufficient structural resilience to maintain its shape without the need of the mold (4). This period will again depend on the content of the bulk cured room temperature condensation curable silicone composition being used to make the cured articles but for a composition that cures over say about one week the curing composition is typically left in the mold for 1 to 4 days, alternatively 1.5 to 3 days at room temperature. If desired, the room temperature curable silicone composition may be heated up to a temperature of about 80° C. to accelerate the cure process after bubble removal as described herein. After this period, the partially cured material may be demolded from the mold (4) whilst keeping it in the film (2) and the cure process is allowed to continue for as long as required and/or deemed necessary to complete the cure process, again typically at room temperature but cure can be accelerated by further heating up to a maximum of about 80° C. In some cases, the final strength of the transparent spacer will be sufficient for the application, whilst in others the use of an additional structural adhesive will be required on top and/or bottom to ensure sufficient strength of the IGU. The high transparency of the pre-cured spacer applied using the present method will contribute to anesthetically pleasing spacer which is visibly clear.

It is to be appreciated that such transparent spacers can be used for building transparent internal partitions, transparent windows and doors, especially for refrigerators, where thermal insulation is desired. The resulting pre-cured spacer produced using the method hereinbefore described, can also be useful for assembling cold or hot bended glass units, where the use of a structural spacer is a clear attribute. If transparent articles can be assembled, non-transparent articles can also be considered in combination or not with transparent articles. The transparent spacer may have decorative, optical and or electronic devices fully or partially incorporated into the body of the spacer prior to curing. Said devices are then cured in the normal manner as previously discussed. The resulting cured transparent spacer produced using the method hereinbefore described, will then have said devices visible therein or on thereon unless hidden from view behind a frame for e.g., security reasons.

The transparent structural spacer produced using the method hereinbefore described, can also be useful to assemble articles, which are sensitive to temperature, ultra-violet or liquids. It can be useful to assemble electronic articles, optical devices, displays made of glass, metals or plastics. It is useful to assemble panels together for internal partition in building but as well for facades and roofs. They may also be useful for assembling articles in appliance, automotive or aerospace, especially where transparency is desirable.

Hence, substrates which may be spaced apart by spacers produced using the method hereinbefore described, may include glass sheets for flat panel displays (LED, LCD screens), glass panels for facades or cars, metal, plastic, wood, concrete or stone plates for construction, automotive, electronics etc. metal, plastic, wood, concrete fixations, like hooks, screws, nuts. If necessary, the substrates may be additionally primed if it is necessary to physically enhance the level of adhesion between the spacer and a substrate.

Insulated glass units may comprise one or more than one spacer. For example, spacers produced using the method hereinbefore described, might be used for articles of a unit which an opaque or coloured spacer would otherwise obscure but other standard spacers might be used in areas where the spacer material will not obscure the vision of the user looking through the unit.

It will be noted that generally the units described are referred to as glass units, it should be understood that whilst glass has been used as an example any alternative transparent materials may be used, if appropriate to the situation. Furthermore, in some instances the insulated glazing unit might comprise one or more transparent panes of glass or the like and one pane which is rendered opaque due to patterning or the like.

### EXAMPLES

In the present examples all viscosity values were measured using an Anton-Paar MCR-301 rheometer fitted with a 25 mm cone-and-plate fixture and operated at 25° C.

In the examples, the part A of the bulk cured room temperature condensation curable silicone composition was a 13,500 mPa·s (at 25° C.) silanol terminated polydimethylsiloxane and part B of the composition comprised 100 weight parts of a 2,000 mPa·s trimethoxysilyl terminated polydimethylsiloxane (at 25° C.) and 0.3 weight parts of tetra-n-butyl titanate, per 100 weight parts of said trimethoxysilyl terminated polydimethylsiloxane. In these examples, part A was mixed with part B in a 3:1 weight ratio and dispensed using a 2-part dispensing machine (Conti Flow Vario 2-component Mix and dispense system from Reinhardt-Technik GmbH of Kierspe Germany).

A predefined amount of the mixed composition was introduced into a plurality of cavities in a mold of the type depicted and described with respect to FIGS. 2A-2C above. The cavities were prepared using a polyethylene release film and had the following dimensions:
Length=1900 mm, width=12.5 mm, height=10 mm.
   Gas bubbles appeared in the composition during and after it was being dispensed into the molds.

When required in the following examples a lid made of polyethylene film was placed on top of the mold and over the cavities therein being used for the examples to form a headspace and dry air was introduced into the headspace. The relative humidity of the headspace was tracked using a Medisana™ HG 100 Digital Thermo-Hygrometer from Medisana GmbH in the case of the comparative example and examples 1 to 3. A testo 623—Thermohygrometer from Testo SE & Co. KGaA was used to measure relative humidity with respect to Example 4 and 5.

### Comparative Example 1

16 cavities in the mold were filled, each with the same predefined amount of the composition. The bulk cured room temperature condensation curable silicone composition was left to cure under ambient conditions with relative humidity at, on average, 50%. After two days of cure the cured silicone articles were each removed from the respective cavity in the mold and visually examined for gas bubbles. Only 25% of the articles produced were gas bubble free.

### Example 1

24 cavities were filled. The silicone was left to cure under ambient conditions, the relative humidity was 30%. After two days of cure the silicone elastomeric parts were taken out and examined for gas bubbles. 71% of the cured silicone articles were gas bubble free.

### Example 2

25 cavities in the mold were filled, each with the same predefined amount of the composition. After the composition had been dispensed into the respective cavity in the mold, the cavities were covered by a polyethylene film and the headspace was flushed with dry air. The relative humidity was determined to be less than 25%. Unfortunately, it was found that Medisana™ HG 100 Digital Thermo-Hygrometer did not seem sufficiently sensitive to provide absolute relative humidity values below about 25%. After two days of cure the fully or partially cured silicone articles were removed from the respective cavities in the mold and examined for gas bubbles. 84% of the parts cured silicone articles were gas bubble free.

### Example 3

20 cavities in the mold were filled, each with the same predefined amount of the composition. After the composition had been dispensed into the respective cavity in the mold, the cavities were covered by a polyethylene film and the headspace was flushed with dry air. The relative humidity was less than 25%. Unfortunately, it was found that Medisana™ HG 100 Digital Thermo-Hygrometer did not seem sufficiently sensitive to provide absolute relative humidity values below about 25%. After two days of cure the silicone elastomeric parts were taken out and examined for gas bubbles. 100% of the parts were gas bubble free.

### Example 4

9 cavities in the mold were filled, each with the same predefined amount of the composition. After the composition had been dispensed into the respective cavity in the mold, the partially cured silicone composition was left to cure under the conditions in the workshop which were room temperature and a relative humidity of 26% determined using with a Testo 623 hygrometer and temperature was 22.7° C. After two days of cure the silicone elastomeric parts were removed from the mold cavities and visually examined for gas bubbles. 89% of the articles were gas bubble free. Only 1 one article (spacer) visually had 2 small gas bubbles remaining.

### Example 5

9 cavities in the mold were filled, each with the same predefined amount of the composition. After the composition had been dispensed into the respective cavity in the mold, the cavities were covered by a polyethylene film and the headspace was flushed with dry air. The relative humidity was measured at 9% with a Testo 623 hygrometer, at 22.7° C. 3 hours 45 minutes after the composition had been dispensed into the mold cavities the polyethylene lid/cover was removed and the composition was left to cure under ambient conditions. The relative humidity was measured to be 26% and temperature was 22.7° C. After two days of cure each of the cured or partially cured silicone articles were removed from the respective mold cavity and examined for gas bubbles. 100% of the silicone articles were gas bubble free.

The results obtained are summarized in Table 1 below.

TABLE 1

| | | Total | % cured | % cured |
|---|---|---|---|---|
| | Relative | number of | silicone | silicone |
| | humidity | elastomeric | articles with | articles with |
| Example | conditions | parts | no gas bubbles | gas bubbles |
| C. Ex. 1 | 50% | 16 | 25% | 75% |
| Example 1 | 30% | 24 | 71% | 29% |
| Example 2 | <25% | 25 | 84% | 16% |
| Example 3 | <25% | 20 | 100% | 0% |
| Example 4 | 26% | 9 | 89% | 11% |
| Example 5 | 9% | 9 | 100 | 0% |

1. A method for reduction of gas bubble entrapment in bulk cured room temperature condensation curable silicone compositions, the method comprising;
applying a predefined volume of a bulk cured room temperature condensation curable silicone composition onto or into a target substrate; and
at least initially curing the composition in an atmosphere having a relative humidity of X %, wherein X has a value in the range of 0<X≤40%, for a predetermined time or until no gas bubbles remain visible in the composition.

2. The method in accordance with claim 1, comprising:
(i) applying a predefined volume of a bulk cured room temperature condensation curable silicone composition onto or into a target substrate;
(ii) enclosing the composition with a cover, which cover has an inner surface such that a headspace is formed between the composition and the inner surface of the cover; and
(iii) introducing a dry gaseous blanket into the headspace and reducing the relative humidity in the headspace to X % for a predetermined time or until no gas bubbles remain visible in the composition.

3. The method f in accordance with claim 2, wherein step (i) is achieved as follows:
(i)(a) draping a film (2) over a mold (4) comprising two or more predefined shapes (6) to establish an evacuatable volume (8) between the film (2) and each predefined shape (6) in the mold (4);
(i)(b) applying suction to the evacuatable volume (8) between a first predefined shape (6a) of the mold (4) and the film (2) to establish an at least partial vacuum within the evacuatable volume (8) of the first predefined shape (6a), such that the film (2) forms a filmic inner lining conforming to the first predefined shape (6a) of the mold (4);
(i)(c) additionally, applying suction to the evacuatable volume (8) between a second predefined shape (6b) of the mold (4) and the film (2), which second predefined shape (6b), is adjacent to the first predefined shape (6a), to also establish an at least partial vacuum within the evacuatable volume of the second predefined shape (6b) and consequently also forms a filmic inner lining conforming to the second predefined shape (6b) of the mold (4);
(i)(d) sequentially repeating step (i)(a) to (i)(c) until each predefined shape (6) in the mold has an at least partial vacuum within the evacuatable volume (8) thereof and the film (2) forms a filmic inner lining conforming to each respective predefined shape (6) of the mold (4); and
(i)(e) introducing bulk cured room temperature condensation curable silicone composition onto the filmic inner lining conforming to one or more predefined shapes (6) of the mold (4), which composition is designed to flow sufficiently to conform to the predefined shape (6) in the mold (4) into which it has been introduced.

4. The method in accordance with claim 1, wherein the relative humidity X has a value in the range of 0<X≤35%.

5. The method in accordance with claim 1, wherein the cure temperature is from 0° C. to 30° C., optionally is at room temperature.

6. The method in accordance with claim 1, wherein the bulk cured room temperature condensation curable silicone composition is a 2-part condensation cure composition comprising a titanium-based catalyst and/or a zirconium-based catalyst.

7. The method in accordance with claim 1, wherein the bulk cured room temperature condensation curable silicone composition comprises:
(i) at least one condensation curable silyl terminated polymer having an average of at least 1.5, optionally an average of at least 2 hydrolysable and/or hydroxyl functional groups per molecule;
(ii) a cross-linker selected from the group of
silanes having at least 2 hydrolysable groups, optionally at least 3 hydrolysable groups per molecule; and/or
silyl functional molecules having at least 2 silyl groups, each silyl group containing at least one hydrolysable group; and
(iii) a condensation catalyst selected from the group of titanates and zirconates;
wherein:
the molar ratio of hydroxyl groups to hydrolysable groups is between 0.1:1 to 4:1; and
the molar ratio of M-OR functions to the hydroxyl groups is from 0.01:1 and 0.6:1, where M is titanium or zirconium and R is an alkyl group.

8. The method in accordance with claim 1, wherein the atmosphere comprises dry air or dry nitrogen.

9. The method in accordance with claim 1, which is vacuum-free.

10. The method in accordance with claim 1, wherein after at least initially curing the composition, the remainder of the cure process takes place at standard room temperature and relative humidity or is accelerated by increasing the room temperature and relative humidity.

11. A shaped cured silicone article obtainable or obtained by the method in accordance with claim 1.

12. A shaped silicone elastomeric article prepared by the method in accordance with claim 1, wherein the article is a spacer in an insulated glass unit or is a potting material for an electronic article.

13. A shaped silicone elastomeric article obtainable or obtained by the method in accordance with claim 1.
